(19) United States
(12) Patent Application Publication
(10) Pub. No.: US 2024/0200398 A1
(43) Pub. Date: Jun. 20, 2024

(54) SYSTEM AND METHOD FOR FLUSH-MOUNTING AN INSULATED GLAZING UNIT TO A DOOR

(71) Applicant: ODL, INCORPORATED, Zeeland, MI (US)

(72) Inventors: Nicholas TONAR, Holland, MI (US); Dale A. GORT, Holland, MI (US); Scott E. CORLEY, Holland, MI (US); Xiaohu QIAO, Suzhou (CN)

(21) Appl. No.: 18/572,626

(22) PCT Filed: Jun. 22, 2022
(86) PCT No.: PCT/US2022/034425

§ 371 Date: Dec. 20, 2023

Related U.S. Application Data
(60) Provisional application No. 63/213,872, filed on Jun. 23, 2021.
(60) Provisional application No. 63/281,151, filed on Nov. 19, 2021.

(51) Int. Cl. E06B 3/58; E06B 7/23

(52) U.S. Cl. CPC E06B 3/5842; E06B 3/5892; E06B 7/2312

(57) ABSTRACT

An arrangement for flush-mounting an insulated glass unit (IG) in a door opening may include at least one frame member configured to be positioned between the door skins along at least one edge of the door opening, and at least one glazing strip having body with a top surface and a bottom surface opposite the top surface and a flange extending away from the body at an acute angle relative to the top surface. With the IG positioned in the door opening and supported along one outer IG panel adjacent to one door skin, the flange is inserted into an opening or channel in the at least one frame member to bring the top surface of the body flush with the other door skin and to bring the bottom surface of the body into contact with an opposite outer IG panel to retain the IG in the opening.

### CROSS-REFERENCE TO RELATED APPLICATIONS

This patent application claim the benefit of, and priority to, U.S. Provisional Patent Application Ser. No. 63/281,151, filed Nov. 19, 2021, and U.S. Provisional Patent Application Ser. No. 63/213,872, filed Jun. 23, 2021, the disclosures of which are expressly incorporated herein by reference in their entireties.

### FIELD OF THE INVENTION

This disclosure relates generally to entry or exterior doors for residential or commercial applications, and more specifically to structures and methods for flush-mounting an insulated glazing unit to such doors.

### BACKGROUND

Entry and/or exterior doors for residential or commercial applications may sometimes be fitted with an insulated glass unit (IG) positioned in an opening formed through the door. Conventional glazing strips are typically secured to opposite faces of such doors about the periphery of the opening to retain and secure the IG in the opening.

### SUMMARY

This disclosure may comprise one or more of the features recited in the attached claims, and/or one or more of the following features and combinations thereof. In a first aspect, a combination may include a door with a first door skin having an outer surface defining one planar surface of the door, a second door skin having an outer surface defining an opposite planar surface of the door, an opening formed through the door and at least a first glazing strip extending over a periphery of the opening and having an outer surface flush with the outer surface of the first door skin, an insulated glass unit (IG), and a mounting arrangement for flush-mounting the IG in the opening defined through the door. The mounting arrangement may comprise at least one frame member positioned between the first and second door skins along at least one edge of the opening of the door, the at least one frame member defining an opening therein, and at least a second glazing strip having body with a top surface and a bottom surface opposite the top surface, and a flange extending away from the body such that the flange forms an acute angle with respect to a plane tangent to a peak height of the top surface of the body, the at least a second glazing strip configured to be mounted to the door such that, with the IG positioned in the opening with one outer panel of the IG in contact with the at least a first glazing strip, insertion of the flange into the opening defined in the at least one frame member engages the at least one frame member with the flange such that the plane tangent to the peak height of the top surface of the body is approximately flush with the outer surface of the second door skin and the bottom surface of the body contacts an opposite outer panel of the IG to retain the IG in the opening.

A second aspect may include the features of the first aspect, and wherein the at least one frame member and the flange may be configured to engage one another such that, with the flange inserted into the opening, the flange is secured to the at least one frame member.

A third aspect may include the features of the second aspect, and wherein the at least one frame member may define a channel in communication with the opening, and wherein the channel and the flange may be configured to engage one another so as to retain the flange within the channel.

A fourth aspect may include the features of the third aspect, and wherein one of the flange and the channel may define at least one protrusion extending from a surface thereof, and the other of the flange and the channel may define at least one notch configured to engage the at least one protrusion upon insertion of the flange into the channel.

A fifth aspect may include the features of the first aspect, and wherein the flange may be configured to engage the second door skin or the at least one frame member such that, with the flange inserted into the opening, the flange is secured to the second door skin or to the at least one frame member.

A sixth aspect may include the features of any of the first through fifth aspects, and wherein the at least a second glazing strip may define a hinge between the body and the flange, and wherein, upon insertion of the flange into the opening defined in the at least one frame member, at least one of the at least one frame member and a terminal edge of the second door skin along the at least one edge of the opening of the door may act against the body to rotate or pivot the body relative to the flange about the hinge so as to force the bottom surface of the body into contact with opposite outer panel of the IG to retain the IG in the opening.

A seventh aspect may include the features of the sixth aspect, and wherein rotating or pivoting of the body relative to the flange about the hinge forces the plane tangent to the peak height of the top surface of the body approximately flush with the outer surface of the second door skin.

An eighth aspect may include the features of the first through seventh aspects, and wherein the top surface of the body is planar such that the plane tangent to the peak height of the top surface of the body is a plane defined by the planar top surface of the body.

A ninth aspect may include the features of the eighth aspect, and wherein the body of the at least a second glazing strip may include a top leg coupled to the flange and a bottom leg coupled to the top leg, an outwardly facing surface of the top leg defining the planar top surface of the body, and a free end of the bottom leg defining the bottom surface of the body.

A tenth aspect may include the features of any of the first through seventh aspects, and wherein the top surface of the body is non-planar such that the plane tangent to the peak height of the top surface of the body is, upon insertion of the flange into the opening defined in the at least one frame member, approximately flush with the outer surface of the second door skin

An eleventh aspect may include the features of any of the first through tenth aspects, and wherein a blind adjustment track is mounted to an outer surface of the IG adjacent to the second door skin such that the blind adjustment track extends approximately parallel with, and spaced apart by a distance D from, the body of the at least a second glazing strip with the flange inserted into the opening defined in the at least one frame member, and wherein the acute angle formed by the flange with respect to the plane tangent to a peak height of the top surface of the body is selected, taking into account the distance D, such that the blind adjustment track will not impede the insertion into, or removal of, the flange into or out of the opening defined in the at least one frame member.

A twelfth aspect may include the features of the first aspect, and wherein the opening defined in the at least one frame member defines at least a first retention structure and the flange defines at least a second retention structure, and wherein the at least a first retention structure and the at least a second retention structure are complementarily configured to engage one another as the flange is inserted into the opening defined in the at least one frame member so as to retain the flange within the at least one frame member.

A thirteenth aspect may include the features of the twelfth aspect, and wherein the at least a first retention structure and the at least a second retention structure are both configured to releasably engage one another such that the flange can be withdrawn from the opening defined in the at least one frame member.

A fourteenth aspect may include the features of the twelfth aspect, and wherein the at least a first retention structure and the at least a second retention structure are both configured to non-releasably engage one another such that, following engagement of the at least a first retention structure and the at least a second retention structure, the flange cannot thereafter be withdrawn from the opening defined in the at least one frame member without damaging at least one of the flange and the at least one frame member.

A fifteenth aspect may include the features of any of the first through fourteenth aspects, and wherein the at least one frame member comprises a plurality of frame members each positioned between the first and second door skins along a different respective edge of the opening of the door such that the plurality of frame members together extend continuously or discontinuously about a periphery of the opening of the door, and wherein the at least a second glazing strip comprises a plurality of second glazing strips together extending continuously about the periphery of the opening of the door and each configured to engage a different respective one of the plurality of frame members.

A sixteenth aspect may include the features of any the first through fifteenth aspects, and wherein the at least a first glazing strip is integral with the first door skin such that the first door skin and the at least a first glazing strip are of unitary construction.

A seventeenth aspect may include the features of any of the first through fifteenth aspects, and wherein the at least a first glazing strip is separate from the first door skin and configured to be coupled to the at least one frame member.

An eighteenth aspect may include the features of any of the first through seventeenth aspects, and wherein the at least a second glazing strip includes at least a first sealing member extending longitudinally along the bottom surface of the body, the at least a first sealing member configured to form a seal with the opposite panel of the IG about its periphery.

A nineteenth aspect may include the features of any of the first through eighteenth aspects, and wherein at least one of the one outer panel of the IG and the opposite outer panel of the IG includes two or more panels sandwiched together or spaced apart from one another.

In a twentieth aspect, a mounting arrangement may be provided for flush-mounting an insulated glass unit (IG) in an opening defined through a door including a first door skin having an outer surface defining one planar surface of the door, a second door skin having an outer surface defining an opposite planar surface of the door and at least a first glazing strip extending over a periphery of the opening and having an outer surface flush with the outer surface of the first door skin. The mounting arrangement may comprise at least one frame member configured to be positioned between the first and second door skins along at least one edge of the opening of the door, the at least one frame member defining an opening or channel therein, and at least a second glazing strip having body with a planar top surface and a bottom surface opposite the planar top surface, and a flange extending away from the body such that the flange forms an acute angle relative to a plane defined by the planar top surface of the body, the at least a second glazing strip configured such that, with the IG positioned in the opening with one outer panel of the IG in contact with the at least a first glazing strip, insertion of the flange into the opening or channel defined in the at least one frame member brings the plane defined by the planar top surface of the body approximately flush with the outer surface of the second door skin defining the opposite planar surface of the door and also brings the bottom surface of the body into contact with an opposite outer panel of the IG to retain the IG in the opening.

A twenty first aspect may include the features of the twentieth aspect, and wherein the acute angle formed by the flange relative to the plane defined by the planar top surface of the body is about 45 degrees.

A twenty second aspect may include the features of the twentieth aspect or twenty first aspect, and wherein a blind adjustment track is mounted to an outer surface of the IG adjacent to the second door skin such that the blind adjustment track extends about parallel with, and spaced apart by a distance D from, the body of the at least a second glazing strip with the flange inserted into the opening or channel defined in the at least one frame member, and wherein the angle formed by the flange with respect to the planar top surface of the body is selected, taking into account the distance D, such that the blind adjustment track will not impede the insertion into, or removal of, the flange into or out of the opening or channel defined in the at least one frame member.

A twenty third aspect may include the features of any of the twentieth through twenty second aspects, and wherein the at least a second glazing strip defines a hinge coupling the body to the flange, the hinge configured such that, as the flange is inserted into the opening or channel defined in the at least one frame member, at least one of the at least one frame member and a corresponding edge of the second door skin facing the opening forces the body to move about the hinge relative to the flange in a direction which forces the bottom surface of the body against the opposite panel of the IG.

A twenty fourth aspect may include the features of any of the twentieth through twenty third aspects, and wherein the at least one frame member defines a channel therein and at least a first retention structure in the channel, and the flange defines at least a second retention structure, and wherein the at least a first retention structure and the at least a second retention structure are complementarily configured to engage one another as the flange is inserted into the channel defined in the at least one frame member so as to retain the flange within the channel.

A twenty fifth aspect may include the features of the twenty fourth aspect, and wherein the at least a first retention structure and the at least a second retention structure are both configured to releasably engage one another such that the flange can be withdrawn from the channel defined in the at least one frame member.

A twenty sixth aspect may include the features of the twenty fourth aspect, and wherein the at least a first retention structure and the at least a second retention structure are both configured to non-releasably engage one another such that, following engagement of the at least a first retention structure and the at least a second retention structure, the flange cannot thereafter be withdrawn from the channel defined in the at least one frame member without damaging at least one of the flange and the at least one frame member.

A twenty seventh aspect may include the features of any of the twentieth through twenty sixth aspects, and wherein the at least one frame member comprises a plurality of frame members each positioned between the first and second door skins along a different respective edge of the opening of the door such that the plurality of frame members together extend continuously or discontinuously about a periphery of the opening of the door, and wherein the at least a second glazing strip comprises a plurality of second glazing strips together extending continuously about the periphery of the opening of the door and each configured to engage a different respective one of the plurality of frame members.

A twenty eighth aspect may include the features of any of the twentieth through twenty seventh aspects, and wherein the at least a first glazing strip is integral with the first door skin such that the first door skin and the at least a first glazing strip are of unitary construction.

A twenty ninth aspect may include the features of any of the twentieth through twenty seventh aspects, and wherein the at least a first glazing strip is separate from the first door skin and configured to be coupled to the at least one frame member.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a perspective view of an embodiment of an entry door which has been prepared with an opening configured to receive an insulated glass unit (IG) therein and which includes example embodiments of glazing strips for flush-mounting the IG to the door.

FIG. 2 is a magnified view of two of the edges of the opening formed in the entry door of FIG. 1 illustrating an embodiment of flush-mounted glazing strips affixed to an exterior side of the door.

FIG. 3 is a perspective view of the entry door illustrated in FIGS. 1 and 2, and showing an IG ready for installation in the opening formed in the door.

FIG. 4 is a magnified perspective view similar to FIG. 2 showing the IG received in the opening formed in the door and supported on the flush-mounted glazing strips affixed to the exterior side of the door.

FIG. 5A is a magnified end view of an embodiment of a insertable glazing strip configured to be secured to the door along the interior side of the door to securely flush-mount the IG to the door.

FIG. 5B is a magnified view of the underside of the insertable glazing strip illustrated in FIG. 5A.

FIG. 6 is a perspective view of the door of FIGS. 1-4 illustrating an example method of attaching one of the insertable glazing strips to the door.

FIG. 7 is a perspective view of the door of FIGS. 1-4 and 6 showing insertable glazing strips mounted to the door about the perimeter of the IG to securely flush-mount the IG to the door.

FIG. 8 is a top plan view of another embodiment of an entry door which has been prepared with an opening in which an insulated glass unit (IG) is installed and which includes another example of glazing strips for flush-mounting the IG to the door.

FIG. 9A is a cross-sectional, perspective view of the door of FIG. 8, as viewed along section lines A-A of FIG. 8, illustrating an embodiment of a frame member and glazing strip member mounted between the door skins and defining one edge of the opening defined through the door, and further illustrating an embodiment of the glazing strip of FIG. 8 mounted to the door and coupled to the frame member and glazing strip member to secure the IG to the door.

FIG. 9B is an end elevational and cross-sectional view similar to FIG. 9A.

FIG. 10A is an end view of the frame member illustrated in FIGS. 9A and 9B.

FIG. 10B is an end view of another embodiment of a frame member for use with the glazing strip illustrated in FIGS. 9A and 9B.

FIG. 11 is an end view of the glazing strip illustrated in FIGS. 9A and 9B.

FIG. 12 is a magnified view of the portion M of FIG. 9B with the IG and the section lines omitted for clarity of illustration.

FIG. 13 is an end view of yet another embodiment of a frame member and glazing strip member shown coupled to another for flush mounting an IG to the door of FIG. 8.

FIG. 14A is an end view of a further embodiment of a frame member.

FIG. 14B is an end view of a further embodiment of a glazing strip configured for use with the frame member illustrated in FIG. 14A to flush mount an IG to the door of FIG. 8.

FIG. 15 is a cross-sectional view similar to FIG. 9B and illustrating yet another embodiment of a frame member and door configured for use with the glazing strip retention member illustrated in FIG. 13 to flush mount an IG to the door.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described. Further still, it is contemplated that any single feature, structure or characteristic disclosed herein may be combined with any one or more other disclosed feature, structure or characteristic, whether or not explicitly described, and that no limitations on the types and/or number of such combinations should therefore be inferred.

This disclosure relates to structures and techniques for flush-mounting an insulated glass unit (IG) to an entry or exterior door of a residential or commercial building. In this way, various different door and IG combinations can be selected after manufacture of each, and/or IG's can be changed in the field as desired. For purposes of this disclosure, the phrase “flush-mounted,” as it is used in the context of an IG mounted in an opening of an entry or interior door, is generally understood in the art to mean that no part of the outer or external surface(s)s of each of the one or more glazing strips which secure the IG in the opening extend(s) proud of the respective outer surfaces of the door about the opening and that at least a portion of the outer or external surface(s) of each of the one or more glazing strips is/are flush with the respective outer surfaces of the door about the opening. In any case, the opposed outer surfaces of the IG are each generally recessed relative to the outer surfaces of the door about the opening and also generally recessed relative to the outer or external surface(s) of each of the one or more glazing strips.

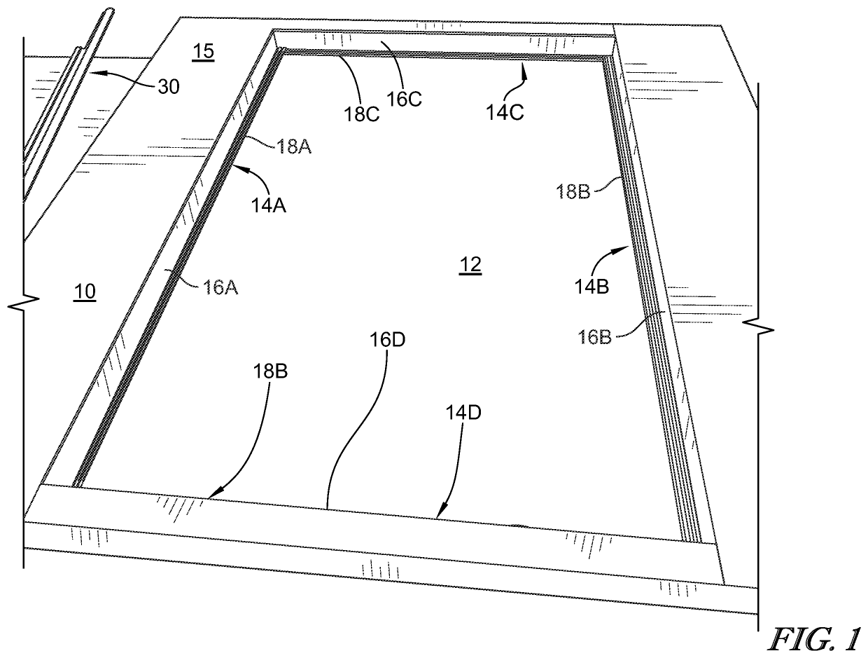

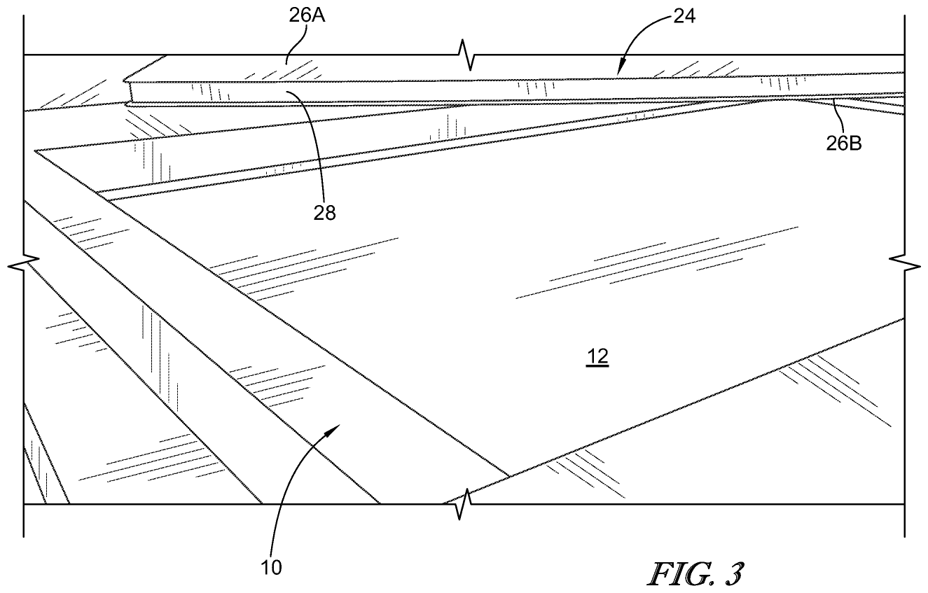

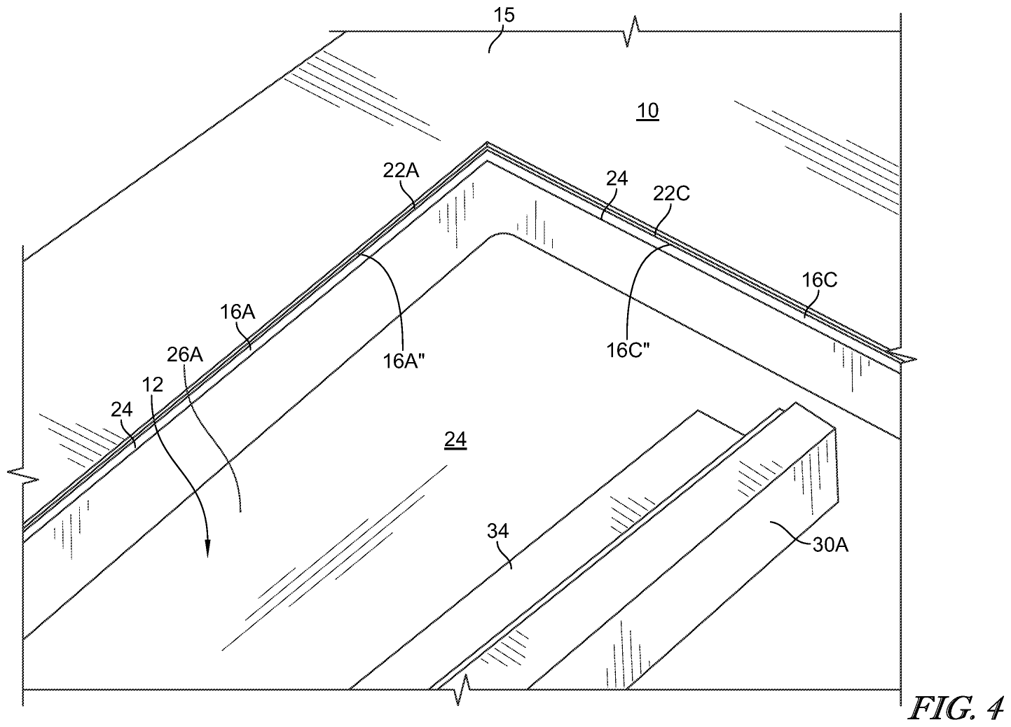

Referring now to FIGS. 1-4, an embodiment is shown of an entry door 10 which has been prepared, i.e., modified, by forming an opening 12 therethrough sized and configured to receive and at least partially retain an insulated glass unit (IG) 24 therein, and which further illustrates in FIG. 1 example embodiments of glazing strips 30 for flush-mounting the IG 24 to the door. As best shown in FIG. 3, the IG 24 is conventional and includes spaced-apart and juxtaposed glazing panels 26A, 26B separated by, and affixed about their peripheries to, a conventional spacer 28 such that an interior space sealed between the panels 26A, 26B and the spacer 28 is hermetically sealed. In the illustrated embodiment, the opening 12 and the IG 24 are both rectangular in shape, although it will be understood that other geometric shapes of the opening 12 and the IG are contemplated by this disclosure. In any case, the dimensions of the four respective sides 14A-14D of the opening 12 are each and together sized slightly larger than the outer dimensions of the IG 24 such that the IG 24 can be received within the opening 12 without binding of the outer periphery or any edges of the IG 24 with any of the sides 14A-14D of the opening 12, as best illustrated in FIG. 4.

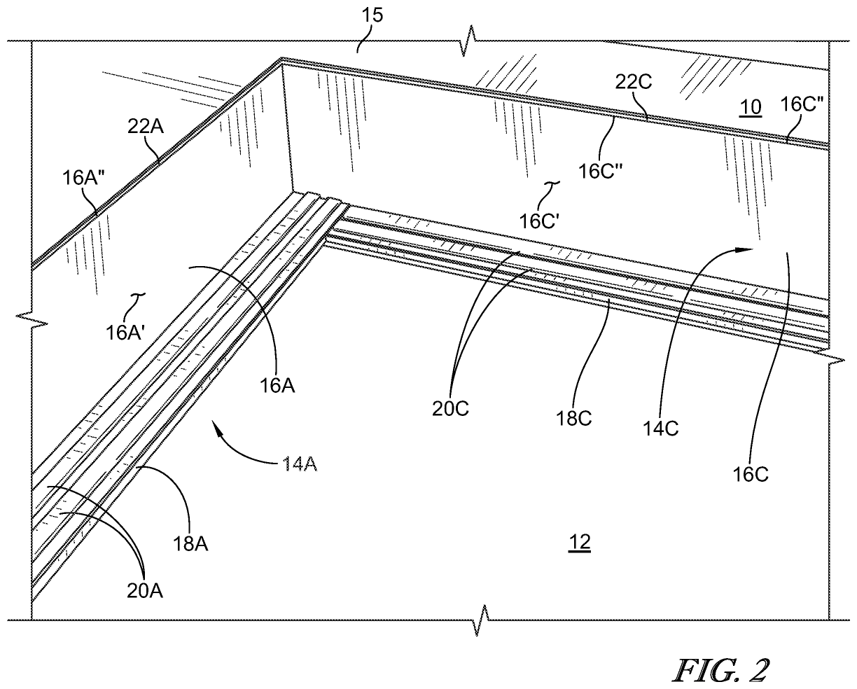

In the illustrated embodiment, the door 10 is a conventional hollow or foam core door having opposed side stiles (not shown) coupled together at their opposite ends by conventional head and bottom rails (not shown), a conventional foam core (not shown) formed between the stiles and rails, and a so-called “skin” 15 wrapped or otherwise formed over and about each of the opposing major surfaces of the door 10. In the illustrated embodiment, the door skin 15 is fiberglass composite (bulk molded or sheet molded compound) or similar material, although in alternate embodiments the door skin 15 be formed of aluminum or other metal or metal composite, or other suitable material known in the art. The opening 12 is formed through the door 10 in a conventional manner, e.g., by cutting with a conventional tool, which exposes inwardly-facing edges of the door skin 15 about the periphery of the opening 12 along each of the opposed major faces of the door 10, and inwardly-facing edges of the foam core between the opposed door skins 15. In the illustrated embodiment, a selected depth of the foam core is removed from the door 10 about the periphery of the opening 12, and frame members 16A-16D of the selected depth are inserted in, and secured to, the channels left by removal of the foam core, each along a respective edge 14A-14B of the opening 12. Illustratively, the exposed, inwardly-facing surfaces of the frame members 16A-16D are each planar surfaces which are themselves co-planar with a respective one of the inwardly-facing edges of the door skin 15, as best shown by the inwardly-facing, planar surfaces 16A′ and 16C′ of the frame members 16A and 16C in FIG. 2. In one embodiment, the depths of the formed channels and of the frame members 16A-16D are approximately ½ inch, although in alternate embodiments these depths may be greater or lesser.

The widths of the frame members 16A-16D are illustratively selected to be less than the thickness of the foam core, i.e., less than the distance between the opposed inner surfaces of the door skin 15, and positioned in the channels so as to leave an elongated, planar slot 22A-22D between the inner surface of the door skin 15 and the top edges of the frame members 16A-16C, as best shown in FIG. 2 by the slots 22A and 22C defined between the inner surface of the door skin 15 and the respective top edges 16A″ and 16C″ of the respective frame members 16A, 16C. As illustrated by example in FIGS. 2 and 4, the slots 22A-22D are generally parallel with the exterior and inner surfaces of the door skin 15 and are also generally parallel with the planes formed by the panel 26A of the IG 24. Along opposite, bottom edges of the frame members 16A-16D, glazing strips 18A-18B are illustratively affixed so as to each extend inwardly into the opening 12 for the purpose of contacting one panel 24A, 24C of the IG 24 about its outer periphery and retaining one side of the IG 24 in the opening 12 when positioned therein. In some embodiments, one or more sealing members may be defined along, or affixed to, the inner surfaces of the glazing strips 18A-18D, as best shown in FIG. 2 by the sealing members 20A, 20C defined along the glazing strips 18A, 18C, to form a seal with and against the panel 26B about its outer periphery.

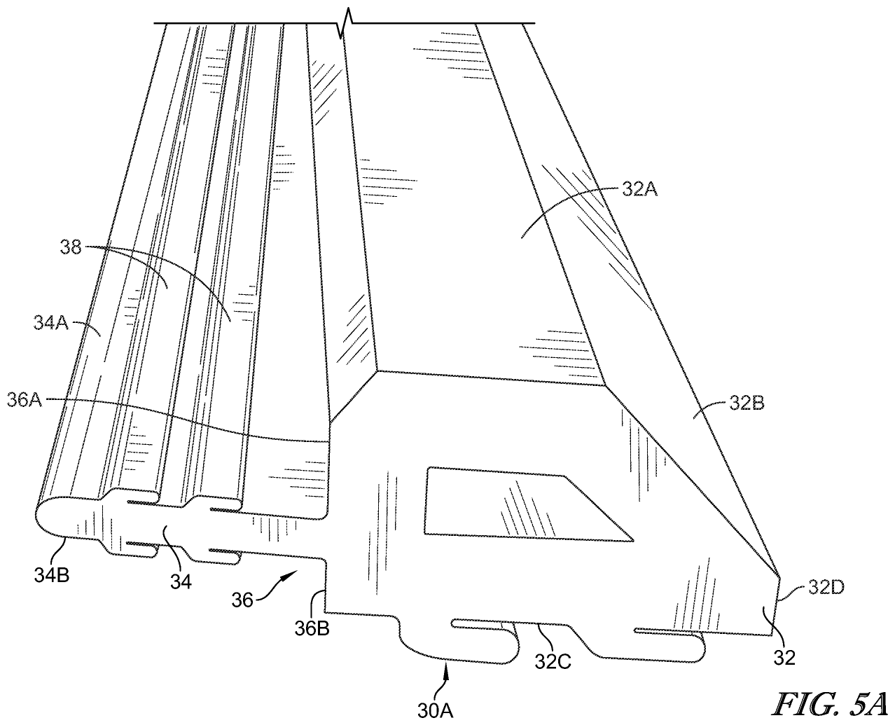

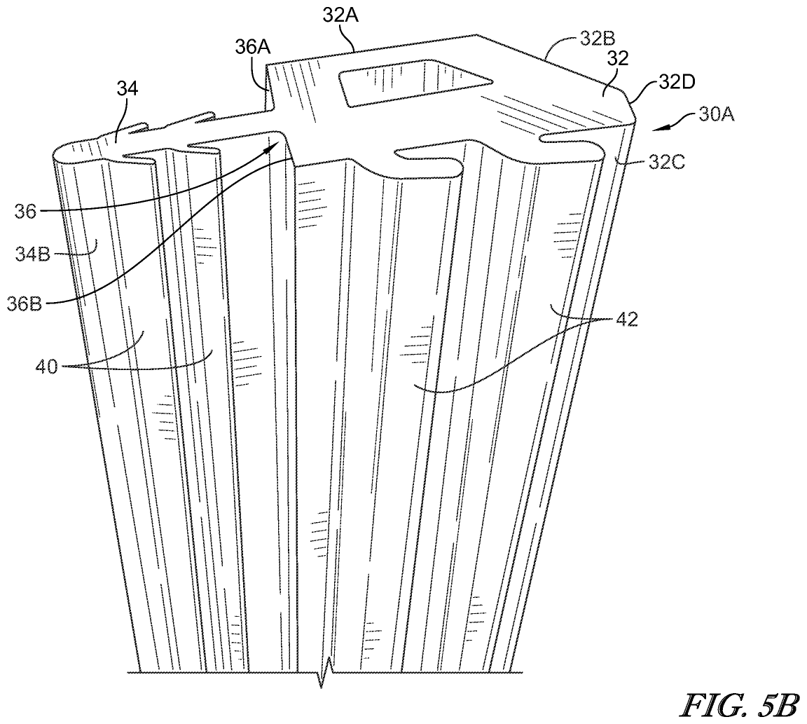

In some embodiments, the glazing strips 18A-18D are identical to the glazing strips 30 depicted in FIGS. 1 and 5A-5B and described in detail below. In such embodiments, the widths of the frame members 16A-16D are sized so as to define elongated slots, identical to the slots 22A-22D, between the inner surface of the door skin 15 and the respective bottom edges of the respective frame members 16A-16D, wherein the glazing strips 18A-18D are configured to engage such slots as described below with respect to FIGS. 5A and 5B. The glazing strips 18A-18B may, in such embodiments, be affixed to the frame members 16A-16D and/or door skin 15, e.g., using a suitable adhesive or other bonding medium, or may instead be insertable and detachable.

In alternate embodiments, the door 10 may not be modified as just described, but may instead be formed or otherwise manufactured to include the opening 12, the frame strips 16A-16D, the glazing strips 18A-18D and the slots 22A-22D. In some such embodiments, the glazing strips 18A-18D may not be separate from the door 10 but may instead be formed integral with the door skin 15, i.e., such that the door skin 15 and the glazing strips 18A-18D are of unitary construction.

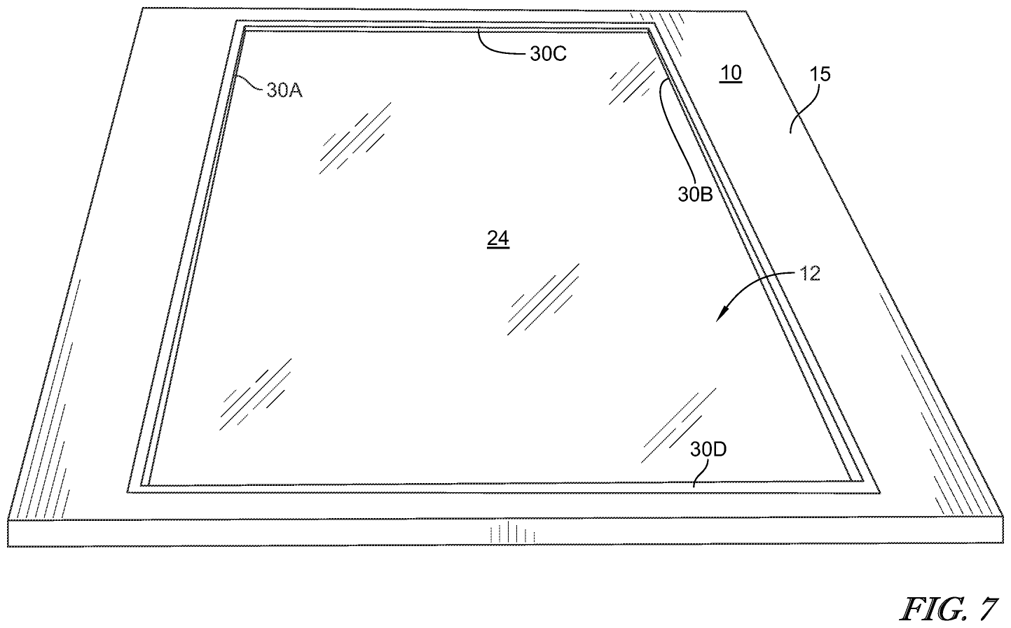

In any case, with the door 10 formed or modified as illustrated in FIGS. 1-2, the IG 24 is inserted into the opening 12 such that the panel 26B is supported by, and retains, the IG 24 therein, as illustrated by example in FIGS. 3 and 4. Insertable glazing strips 30, illustratively comprising glazing strips 30A-30D for the rectangular IG 24 as illustrated by example in FIG. 7, are then mounted to the door 10 about the periphery of the outer surface of the opposite panel 26A so as to retain the IG 24 within the opening 12 of the door, as illustrated in FIG. 4 by the insertable glazing strip 30A.

Referring now to FIGS. 5A and 5B, an embodiment is shown of one of the insertable glazing strips 30A for flush-mounting, securing and retaining the IG 24 in the opening 12 of the door. In the illustrated embodiment, the glazing strip 30A has a length sized to extend along the edge 14A of the opening 12 to and between the edges 14C and 14D. The glazing strips 30B-30D likewise have lengths sized to extend completely along a respective edge 14B-14D of the opening 12 such that the glazing strips 30A-30D together extend completely about the periphery of opening 12 and completely about the periphery of the panel 26A of the IG 24 as shown by example in FIG. 7. In alternate embodiments, the one or more glazing strips may be shaped complementarily to the geometry of the opening 12.

The glazing strip 30A depicted by example in FIGS. 5A and 5B illustratively has an elongated body 32 defining a planar exterior (top) surface portion 32A which transitions downwardly from a shared long edge to a sloped surface portion 32B. An opposite long edge of the sloped surface portion 32B steps downwardly to another planar portion 32D which terminates at a planar bottom portion 32C. The planar bottom portion 32C is illustratively parallel with the planar exterior portion 32A. At an opposite long edge of the planar surface portion 32A, the body 32 steps downwardly to another planar surface portion 36 which, along with the planar portion 32D, is illustratively normal to the planar exterior portion 32A, and which terminates at the planar bottom portion 32C. The body 32 is sized and configured such that, when mounted to the door 10 as described below, the planar exterior portion 32A will be co-planar, or flush, with the exterior surface of the door skin 15, the sloped surface portion 32B will slope downwardly toward the IG panel 26A, the planar portion 32D will step downwardly from the sloped surface portion 32B to the IG panel 26A, and the bottom planar surface 32C will face and contact the IG panel 26A. In the illustrated embodiment, two sealing members 42 are defined longitudinally along the bottom planar surface 32C of the body 32 of the glazing strip 30A to form a seal with and against the panel 26A about its outer periphery.

A planar flange 34 extends perpendicularly away from the planar surface portion 36 and extends along the length of the body 32. The flange 34 is positioned relative to the planar surface portion 36 such that it generally aligns with the slot 22A defined in the edge 14A of the opening 12. The lateral width of the flange 34 is illustratively sized such that it extends fully into the slot 22A upon mounting of the glazing strip 30A to the door 10. In the illustrated embodiment, two sealing members 38 are defined longitudinally along the top planar surface 34A of the flange 34, and two similar or identical sealing members 40 are defined longitudinally along the bottom planar surface 34B of the flange 34. The sealing members 38, 40 are illustratively configured such that the flange 34 forms a friction fit between the inwardly-facing surface, or underside, of the door skin 15 and the top surface 16A″ of the frame member 16A as the flange 34 is forced into the slot 22A.

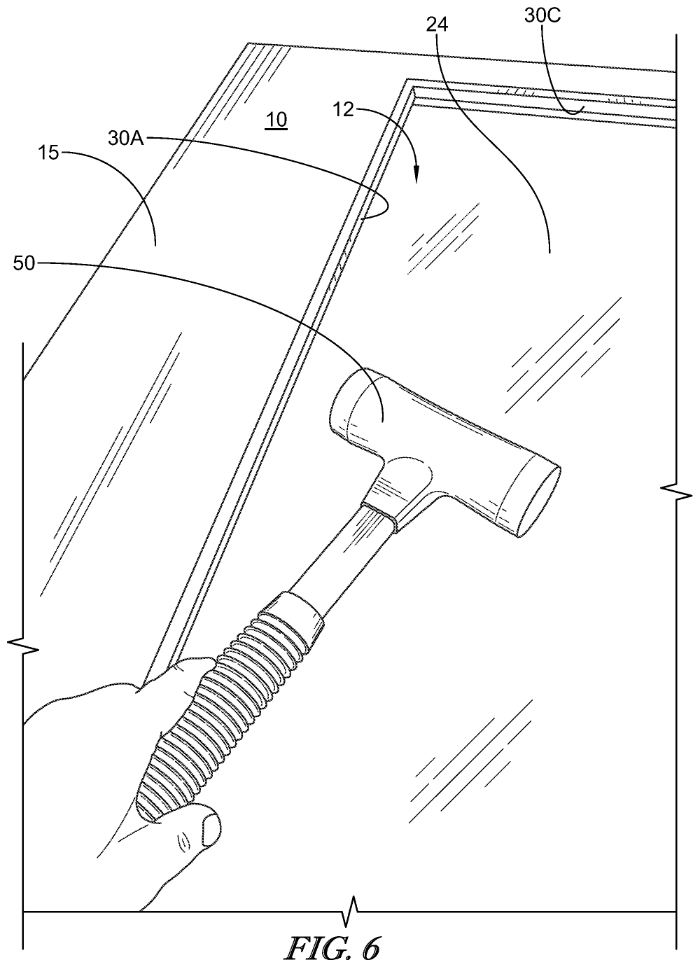

As depicted in FIG. 4, the glazing strip 30A is mounted to the door 10 by first positioning the glazing strip 30A on the IG panel 26A with the flange 34 facing the slot 22A. In this position, the flange 34 is generally aligned with the slot 22A, and as the flange 34 is forced into the slot 22A, the sealing members 38, 40 form a friction fit with the respective surfaces of the door skin 15 and the frame member 16A as described above. In some implementations, the flange 34 can be forced into the slot 22A by hand such that not tools will be required. In other implementations, a mallet 50 or similar tool may be used to tap the flange 34 into the channel 22A as illustrated by example in FIG. 6. In any case, as the flange 34 is forced into the slot 22A, the sealing members 42 press against the top surface of the IG panel 26A and form a seal with and against the panel 26A. With the flange 34 fully extending into the channel 22A, the planar portion 36A of the planar surface 36 of the body 32 extending above the flange 34 abuts the planar edge of the door skin 15, and the planar portion 36B of the planar surface 36 of the body 32 extending below the flange 34 abuts the planar face 16A″ of the frame member 16, and the planar top 32A of the body 32 is co-planar or flush with the exterior surface of the door skin 15 as also illustrated in FIG. 6.

The remaining glazing strips 30B-30D are mounted to the door 10 in the same manner as just described, and as illustrated in FIG. 7, so as to retain the IG 24 in the opening 12 while also forming a seal with and against the panel 26A about its periphery. In one embodiment, the glazing strips 30A-30D are formed of a plastic material via extrusion, although in alternate embodiments the glazing strips 30A-30D may be formed of one or more other suitable materials.

In the illustrated embodiment, the glazing strips 30A-30D can be detached and removed by forcing the flanges 34 of the glazing strips 30A-30D out of the respective channels 22A-22D defined in the edges 14A-14D of the opening. In some implementations, this may be accomplished by hand, and in other implementations a bladed tool, such as a putty knife, chisel, flat-head screwdriver or the like, may assist the process by positioning the blade of the tool at the junction of the planar top surface 32A and the planar surface 36 of one of the glazing strips 30A-30D and tapping the opposite end of the tool in a direction which forces the respective flange 34 out of the respective slot 22A-22D. The remaining glazing strips may be detached and removed similarly. With the glazing strips 30A-30D all removed, the IG 24 may be replaced with another IG 24, and the glazing strips 30A-30D can then be remounted to the door 10 as described above.

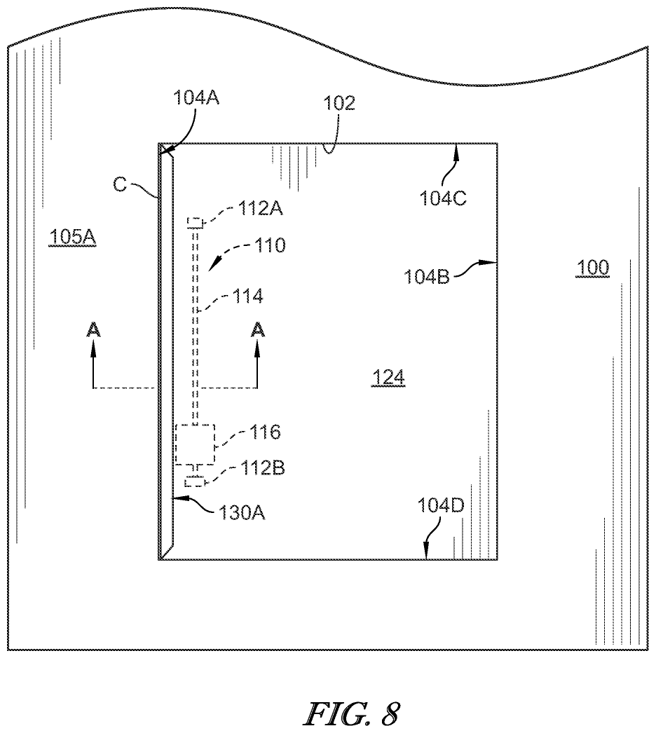

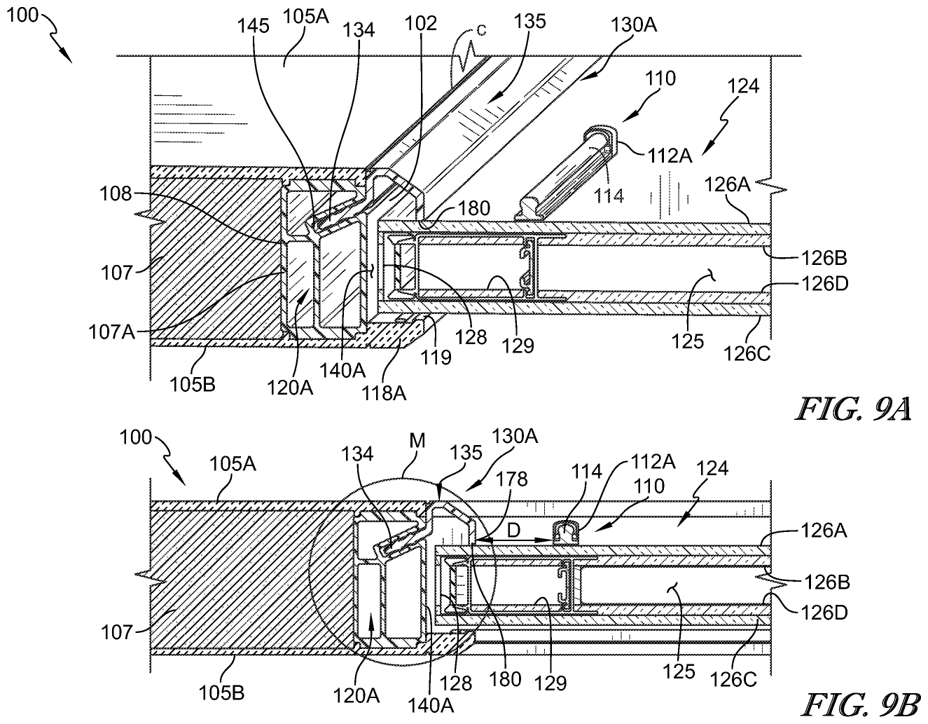

Referring now to FIGS. 8-12, another embodiment is shown of an entry door 100 which has been prepared with an opening 102 in which an insulated glass unit (IG) 124 is installed and which includes another example of glazing strips for flush-mounting the IG 124 to the door 100. Whereas only a single glazing strip 130A is shown in the embodiment illustrated in FIGS. 8-12, this is done only for the purpose of showing illustrative glazing strip embodiments, and it will be understood that multiple such glazing strips will typically be used in a mounting arrangement to secure the IG 124 to the door 100 about the periphery of the opening 102 as illustrated and described above with respect to FIGS. 1-7. As best shown in FIGS. 9A and 9B, the IG 124 is conventional and includes spaced-apart and juxtaposed pairs of glazing panels 126A, 126B and 126C, 126D separated by, and affixed about their peripheries to, a conventional spacer 128 such that an interior space 125 is defined between the panel pairs 126A, 126B, the panel pairs 126C, 126D and the spacer 128 is hermetically sealed. In the illustrated embodiment, the panel pairs 126A, 126B are sandwiched together and the panel pairs 126C, 126D are likewise sandwiched together, although in alternate embodiments the panel pairs 126A, 126B may be spaced apart from one another and/or the panel pairs 126C, 126D may be spaced apart from one another. In other alternate embodiments, only one side of the IG 124 may include two (or more) panels sandwiched together or spaced apart from one another.

In some embodiments, the IG unit 124 may be configured to include a blind assembly therein, and in some such embodiments a blind follower channel 129 may be positioned within the space 125 adjacent to one side of the spacer 128, and a blind adjustment track 110 may be affixed to the panel 126A over and/or adjacent to the follower channel 129, as depicted by example in FIGS. 9A and 9B. In such embodiments, a conventional blind raise/lower and/or tilt adjustment operator 116 will be configured to engage the track 110, as illustrated by dashed-line configuration in FIG. 8. The operator 116 is movable along the track 110 and is configured to couple to, e.g., magnetically or mechanically, a conventional blind follower assembly (not shown) movably disposed within the blind follower channel 129, such that the operator 116 moving along the track 110 also moves the blind follower assembly to raise/lower the blind assembly and/or to tilt one or more slats of the blind assembly in a conventional manner. In the example illustrated in FIGS. 8, 9A and 9B, the track 110 includes an elongated track strip 114 spaced apart by a distance D from, and extending substantially parallel to, the glazing strip 130A, and affixed at opposite ends thereof to the outer, exposed surface of the IG panel 126A by end caps 112A and 112B. As will be described in greater detail below, the glazing strips, e.g., the glazing strip 130A, are illustratively configured so as to allow for insertion and removal of the strip 130A without contacting or otherwise being impeded by the blind adjustment track 110. In alternate embodiments, the IG unit 124 may not be configured to carry a blind assembly, and in such embodiments the blind adjustment track 110 and the blind follower channel 129 may be omitted.

In the illustrated embodiment, the opening 102 and the IG 124 are both rectangular in shape, although it will be understood that other geometric shapes of the opening 102 and the IG 124 are contemplated by this disclosure. In any case, the dimensions of the four respective sides 104A-104D of the opening 102 are each and together sized slightly larger than the outer dimensions of the IG 124 such that the IG 124 can be received within and removed from the opening 102 without binding of the outer periphery or any edges of the IG 124 with any of the sides 104A-104D of the opening 102.

In the illustrated embodiment, the door 100 is as described above with respect to FIGS. 1-7 and is a conventional hollow or foam core door having opposed side stiles (not shown) coupled together at their opposite ends by conventional head and bottom rails (not shown), a conventional foam core 107 formed between the stiles and rails, and so-called “door skins” 105A, 105B wrapped or otherwise formed over and about each of the opposing major surfaces of the door 100, as best shown in FIGS. 9A and 9B. In the illustrated embodiment, the door skins 105A, 105B are a fiberglass composite (bulk molded or sheet molded compound) or similar material, although in alternate embodiments the door skins 105A and/or 105B may be formed of aluminum or other metal or metal composite, or other suitable material known in the art. The opening 102 is formed through the door 100 in a conventional manner, e.g., by cutting with a conventional tool, which exposes inwardly-facing edges of the door skins 105A, 105B about the periphery of the opening 102 along each of the opposed major faces of the door 100, and inwardly-facing edges of the foam core 107 between the opposed door skins 105A, 105B. In the illustrated embodiment, a selected depth of the foam core 107 is removed from the door 100 about the periphery of the opening 102, and frame members of the selected depth are inserted in, and secured to, the channels left by removal of the foam core 107, each along a respective edge 104A-104B of the opening 102. Whereas only a single glazing strip frame member 120A is shown in the embodiment illustrated in FIGS. 8-12, this is done only for the purpose of showing illustrative frame member embodiments, and it will be understood that multiple such frame members will typically be used in a mounting arrangement to secure the IG 124 to the door 100 about the periphery of the opening 102 as illustrated and described above with respect to FIGS. 1-7. In any case, the exposed, inwardly-facing surfaces of the frame members are each planar surfaces which are themselves co-planar with respective inwardly-facing edges of the door skins 105A, 105B, as best shown in FIGS. 9A and 9B in which the inwardly-facing, planar surface 140A of the frame member 120A is shown flush, i.e., co-planar, with the terminal, inwardly-facing edges of the door skins 105A, 105B, i.e., such that the inwardly-facing edges of the doors skins 105A, 105B and the inwardly-facing planar surface 140A of the frame member 120A together form co-planar surfaces. In one embodiment, the widths, W, of the frame members, and the depths of the corresponding channels formed in the core 107, are approximately ½ inch, although in alternate embodiments these depths may be greater or lesser.

The widths of the frame members are illustratively selected to be the same thickness as that of the foam core 107, and positioned in the channels left by removal of the foam core 107 so as to abut the inner, opposed surfaces of the door skins 105A, 105B, as illustrated by the frame member 120A depicted in FIGS. 9A and 9B. In the embodiment illustrated in FIGS. 9A and 9B, glazing strips, e.g., glazing strip 118A, extend from the door skin 105B at least partially over the opening 102 so as to form a support surface 119 for contacting the panel 126C of the IG unit 124 about its periphery and retaining one side of the IG 124 in the opening 102 when positioned therein. In the illustrated embodiment, the glazing strips, e.g., the glazing strip 128A, are integral with the door skin 105B such that the glazing strips, e.g., the glazing strip 128A, and the door skin 105B are of unitary construction, although in alternate embodiments the glazing strips, e.g., the glazing strip 128A, may be separate from the door skin 105B and attached or affixed thereto in a conventional manner. In some embodiments, one or more sealing members may be defined along, or affixed to, the inner surfaces of the glazing strips, e.g., the glazing strip 128A, to form a seal with and against the panel 126C about its outer periphery.

In some embodiments, the glazing strips, e.g., the glazing strip 128A, are identical to the glazing strips, e.g., the glazing strip 130A, depicted in FIGS. 9A-9B and 11-13 and described in detail below. In such embodiments, the frame members, e.g., the frame member 120A illustrated in FIGS. 9A-13, are configured so as to define slots or openings, identical to the openings or channels 145, 145′ (see FIGS. 9A, 10A-10B and 12-13), adjacent to or spaced apart from the door skin 105B, as the openings or channels 145, 145′ are adjacent to or spaced apart from the door skin 105A as described below. In such embodiments, the glazing strips, e.g., the glazing strip 118A, will be identical to the glazing strips, e.g., the glazing strip 130A, 130A′ depicted by example in FIGS. 9A-9B and 11-13, wherein the glazing strips will be configured to engage such slots or openings as described below. Such glazing strips may, in such embodiments, be affixed to the frame members and/or door skin 105B, e.g., using a suitable adhesive or other bonding medium, or may instead be insertable and detachable. In alternate embodiments, the door 10 may not be modified as just described, but may instead be formed or otherwise manufactured to include the opening 102, the frame members, e.g., the frame member 102A, and the glazing strips, e.g., the glazing strips 118A.

In any case, with the door 100 formed or modified as illustrated in FIGS. 8-9B, the IG 124 is inserted into the opening 102 such that the panel 126C is supported by, and retains, the IG 124 therein, as illustrated by example in FIGS. 9A and 9B. Insertable glazing strips, e.g., glazing strip 130A, illustratively comprising four such glazing strips for the rectangular IG 124 illustrated by example in FIGS. 8-9B, are then mounted to the door 100 about the periphery of the outer surface of the opposite panel 126A so as to retain the IG 124 within the opening 102 of the door, as illustrated by example in FIGS. 9A and 9B.

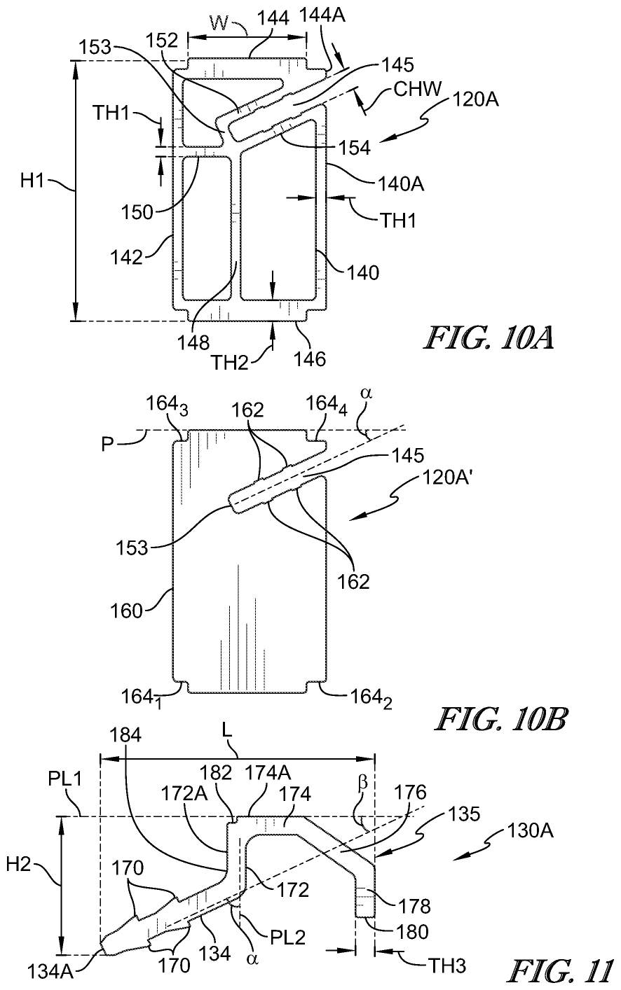

Referring now to FIGS. 9A-11, details of an embodiment of the frame member 120A and of the glazing strip 130A will now be described. Referring specifically to FIG. 10A, the frame member 120A illustratively includes a front wall 140 defining an inwardly-facing or opening-facing planar surface 140A of the frame member 120A, i.e., a planar surface 140A which faces inwardly toward the opening 102 defined through the door 100, and a rear wall 142 configured to face, and in some embodiments be attached or affixed to in a conventional manner, e.g., via adhesive or other conventional bonding medium, a surface 107A of the foam core 107 remaining after forming the channel in the foam core 107 about the opening 102 as described above. The rear wall 142 is coupled at a top end thereof to a top wall 144 configured to face, and in some embodiments be attached or affixed to in a conventional manner, e.g., via adhesive or other conventional bonding medium, the inner surface of the door skin 105A which faces the opposite door skin 105B. The bottom ends of the front and rear walls 140, 142 respectively of the frame member 120A are coupled to respective ends of a bottom wall 146 configured to face, and in some embodiments be attached or affixed to in a conventional manner, e.g., adhesive or other bonding medium, the inner surface of the door skin 150B which faces the opposite door skin 105A.

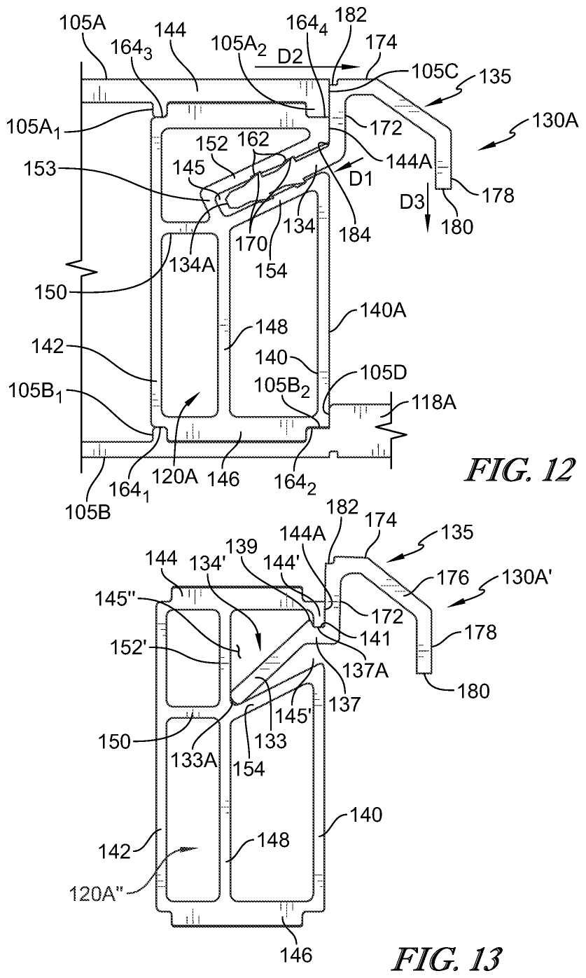

In addition to, or alternatively to, the mechanism and/or medium used to attach the top wall 144 to the inwardly-facing surface of the door skin 105A and/or to attach the bottom wall 146 to the inwardly-facing surface of the door skin 105B, the top wall 144 and the inwardly-facing surface of the door skin 105A and/or the bottom wall 146 and the inwardly-facing surface of the door skin 105B may be complementarily keyed such that frame member 120A may be snap-fit to and between the door skins 105A, 105B within the channel formed in the foam core 107 about the opening 102. One example of such keyed surfaces, which are not to be considered limiting in any way, are illustrated by example in FIG. 10B and 12 and will be described below. In other alternate embodiments, the frame members 120A-120D may be formed integral with the door 100, i.e., 100 during fabrication of the door 100. In some such embodiments, the frame members 120A-120D and the door skins 105A, 105B may be of unitary construction, and in other such embodiments the frame members 120A-120D and the door skins 105A, 105B may be formed separately from, but bonded to, one another during the fabrication of the door 100. In any case, an intermediate wall 148 is illustratively positioned

between the front and rear walls 140, 142 of the frame member 120A, and is coupled at a bottom end thereof to the bottom wall 146. In the illustrated embodiment, the front and rear walls 140, 142 and the intermediate wall 148 are all parallel with one another, although in alternate embodiments one or more of the walls 140, 142, 148 may be non-parallel with one or both of the other walls 140, 142, 148. The top end of the intermediate wall 148 is coupled to a junction of one end of a transverse wall 150, to one end of an end wall 153 defining a channel 145 into the frame member 120A and to one end of a side wall 154 of the channel 145. The opposite end of the side wall 154 is coupled to a top end of the front wall 140, and the opposite end of the transverse wall 150 is coupled to the rear wall 142 between the opposite ends thereof. The opposite end of the end wall 153 of the channel 145 is coupled to one end of another side wall 152 of the channel 145, and an opposite end of the side wall 152 is coupled to an opposite end 144A of the top wall 144 such that the opening of the channel 145 is defined between the junction of the end 144A of the top wall 144 and the junction of the top end of the front wall 140 and the respective end of the channel side wall 154.

The end 144A of the top wall 144 illustratively has a planar surface facing the opening 102 defined through the door 100, and the channel 145 is formed at an acute angle α relative to a plane P formed by the planar outer surface of the top wall 144 of the frame member 120A (see FIG. 10B). With the frame member 120A mounted to the door 100 as illustrated by example in FIGS. 9A and 9B (i.e., between the inwardly facing surfaces of the door skins 105A, 105B with the outer, planar surface 104A of the front wall 140 facing the opening 102 defined through the door 100), the plane P formed by the planar outer surface of the top wall 144 of the frame member 120A is illustratively parallel with the planar outer surface of the door skin 105A, such that a is likewise an acute angle relative to the plane formed by the outer surface of the door skin 105A. In some embodiments, the angle α is approximately 45 degrees, although in alternate embodiments the angle α may be any angle less than 90 degrees. In any case, in the embodiment illustrated in FIG. 10A, the walls 140-154 are illustratively of uniform construction and, in some embodiments, are formed of a polymer resin in accordance with a conventional extrusion process. In some embodiments, the spaces between the walls 140-154 are devoid of any structure, i.e., are open or hollow, although in alternate embodiments the space between the walls 140, 146, 148 and 154, the space between the walls 142, 146, 148 and 150 and/or the space between the walls 142, 144, 150, 152 and 153 may be filled with a polymer foam and/or other suitable material. In one example implementation, which should not be considered to be limiting in any way, the dimensions illustrated in FIG. 10A may be as follows, although it will be understood that in alternate embodiments one or more of the following dimensions may be greater or lesser, depending upon the particular application: W=23.4 millimeters (mm), H1=40.1 mm, TH1=1.5 mm, TH2=3.2 mm, and CHW=3.2 mm.

Referring now to FIG. 10B, an alternate embodiment is shown of the frame member 120A′. The frame member 120A′ is illustratively a solid structure 160, e.g., foamed polyvinyl chloride (PVC) or other suitable material, having external surfaces matching those of the frame member 120A illustrated in FIG. 10A and defining therein a channel 145 identical to the channel 145 illustrated in FIG. 10A. In some embodiments, the corners 1641-1644 of the frame member 120A′ are notched to receive correspondingly configured protrusions formed on, or attached to, the inwardly-facing surfaces of the door skins 105A, 105B. In some embodiments, the respective corners of the frame member 120A illustrated in FIG. 10A may likewise include such notches to receive correspondingly configured protrusions formed on, or attached to, the inwardly-facing surfaces of the door skins 105A, 105B as shown by example in FIGS. 9A and 9B. In some embodiments, the walls of the channel 145 of the frame member 120A′ illustrated in FIG. 10B may include notches or channels 162 to engage correspondingly configured protrusions formed on the glazing strip 130A as will be described below with respect to FIG. 11. In some embodiments, the channel 145 formed in and by the frame member 120A illustrated in FIG. 10A may likewise include such notches or channels 162.

Referring now to FIG. 11, an embodiment is shown of the glazing strip 130A illustrated in FIG. 8. It will be understood that each of the remaining number of glazing strips used to retain the IG unit 124 within the opening 102 defined through the door 100 will be identically or similarly configured. In the illustrated embodiment, the glazing strip 130A illustratively includes a flange 134 having a free end 134A and an opposite end coupled to or integral with a glazing strip body 135. The body 135 illustratively includes a leg 172 having one end coupled to the opposite end of the flange 134 and an opposite end coupled to one end of a top wall 174. In some embodiments, the outer, exposed surface of the junction of the leg 172 and the top wall 174 defines a notch 182 sized to form a channel C between the top wall 174 of the glazing strip 130A and the inwardly-facing edge of the door skin 105A, wherein the channel C runs parallel to and with the inwardly-facing edge of the door skin 105A and the top wall 174 of the glazing strip 130A along the length of the respective side 104A of the opening 102 formed through the door 100 (see, e.g., FIGS. 8 and 9A). In the illustrated embodiment, the top surface 174A of the top wall 174 is planar and defines a plane PL1 as illustrated by example in FIG. 11 and, with the glazing strip 130A mounted to the frame member 120A as illustrated by example in FIGS. 9A and 9B, the plane PL1 formed by the planar top surface 174A of the top wall 174 is at least approximately co-planar with the external or outer surface of the door skin 105A. In alternate embodiments, the top surface 174A of the top wall 174 may be non-planar, and in such embodiments the plane PL1 is tangent to a peak height of the top surface 174A of the top wall 174 such that, with the glazing strip 130A mounted to the frame member 120A as illustrated by example in FIGS. 9A and 9B, the plane PL1 tangent to the peak height of the top surface 174A of the top wall 174 is at least approximately co-planar with the external or outer surface of the door skin 105A so that the peak height of the top surface 174A of the top wall 174 is at least approximately flush with the plane defined by the planar, external surface of the door skin 105A. In any case, as also illustrated by example in FIG. 11, the flange 134 extends away from the body 135 at an acute angle α defined between a plane defined longitudinally through the elongated flange 134 and the plane PL1 formed by the planar top surface 174A of the top wall 174 or tangent to the peak height of the top surface 174A. In the illustrated embodiment, the angle α is approximately 45 degrees, although in alternate embodiments the angle α may be any angle less than 90 degrees. In embodiments which include the blind adjustment track 110 illustrated by example in FIGS. 8, 9A and 9B, the angle α is illustratively selected, taking into account the distance D between the edge of the elongated track strip 114 which faces the glazing strip 130A and the outer surface of the bottom wall 178 of the body 135 of the installed glazing strip 130A, so as to allow for insertion and removal of the strip 130A into the frame member 120A without the elongated track strip 114 or any other portion of the blind adjustment track 110 impeding such insertion and/or removal, e.g., such that the elongated track strip 114 or any other portion of the blind adjustment track 110 does not come into contact with the bottom wall 178 or any other part of the body 135 of the glazing strip 130A during insertion of the glazing strip 130A into the frame member 120A or during removal of the glazing strip 130A from the frame member 120A.

An opposite end of the top wall 174 of the body 135 of the glazing strip 130A is coupled to one end of a sloped wall 176 which illustratively slopes downwardly away from the top wall 174, and an opposite end of the sloped wall 176 is coupled to one end of a bottom wall 178 having an opposite free end 180. The free end 180 of the bottom wall 178 forms a bottom surface of the body 135 of glazing strip 130A that is configured to contact the outer, exposed surface of the IG panel 126A to secure the IG unit 124 to and within the opening 102 defined through the door 100, as illustrated by example in FIGS. 9A and 9B. The junction defined between the coupled ends of the flange 134 and the leg 172 illustratively defines a hinge 184 between the flange 134 and the body 135 of the frame member 120A. As the flange 134 is fully inserted into the channel 145 in the direction D1 (see FIG. 12), the channel 145 engages the flange 134, and the combination of the end 144A of the top wall 144 of the frame member 120A and the inwardly facing terminal edge of the door skin 105A act against the leg 172 in the direction D2 (see FIG. 12) to cause the body 135 of the glazing strip 130A to rotate or pivot away from the flange 134 about the hinge 184 and thereby force the bottom surface 180 of the body 135 in the direction D3 (see FIG. 12) into contact with the outer surface of the IG panel 126A to retain the IG unit 124 within the opening 102 defined through the door 100, as also illustrated by example in FIGS. 9A and 9B. In some embodiments, the glazing strip 130A may be configured such that rotation or pivoting of the body 135 away from the flange 134 about the hinge 184 also forces the top surface 174A of the top 174 wall (i.e., either the entire top surface 174A in embodiments in which the top surface 174A is planar, or the top-most peak of the top surface 174A in embodiments in which the top surface 174A is non-planar) to be substantially flush with the planar outer surface of the door skin 105A. In some alternate embodiments, the end 144A of the top wall 144 of the frame member 120A may extend beyond the inwardly facing terminal edge of the door skin 105A, and in such embodiments only the end 144A of the top wall 144 of the frame member 120A will act against the leg 172 in the direction D2 to force the body 135 of the glazing strip 130A to rotate or pivot away from the flange 134 as just described. In other alternate embodiments, the inwardly-facing terminal edge of the door skin 105A may extend beyond the end 144A of the top wall 144 of the frame member 120A, and in such embodiments only the inwardly-facing terminal edge of the door skin 105A will act against the leg 172 in the direction D2 to force the body 135 of the glazing strip 130A to rotate or pivot away from the flange 134 as just described.

In embodiments which include one or more channels 162 formed in the walls of the channel 145, the flange 134 may define one or more corresponding protrusions 170 on and along the surface thereof and configured to engage the respective channel(s) 162, i.e., to be captured by the channel(s) 162, to thereby retain the flange 134 of the glazing strip 130A within the channel 145 of the frame member 120A. The channel(s) 162 and protrusion(s) 170 are thus complementarily retention structures configured to engage one another as the flange 134 is inserted into the channel 145 so as to retain the flange 134 within the channel 145. In alternate embodiments, the one or more channels 162 may be formed on and along the surface of the flange 134, and the one or more corresponding protrusions 170 may be formed on the walls of the channel 145. In any case, in some embodiments, the protrusions 170 and channels 162 are configured to allow the flange 134 to be removed and re-inserted, although in some alternate embodiments the protrusions 170 and channels 162 may be configured for a single insertion, i.e., such that, once inserted, the flange 134 cannot be withdrawn from the channel 145 without damaging the flange 134 and/or the channel 145.

In the embodiment illustrated in FIGS. 9A-12, the body 135 of the glazing strip 130A is illustratively piece-wise linear, and is formed integral with the flange 134, i.e., such that the flange 134 and the body 135 are of unitary construction. In some embodiments, the flange 134 may be a polymer formed by a conventional extrusion or other conventional process. In alternate embodiments, the body 135 may be formed separately from the flange 134, and the flange 134 and body 135 may be joined together after formation of each. In any case, the flange 134 and/or the body 135 may, in alternate embodiments, be formed of any suitable material. In some alternate embodiments, the body 135 may have any shape or cross-sectional profile without limitation. In one example implementation, which should not be considered to be limiting in any way, the dimensions illustrated in FIG. 11 may be as follows, although it will be understood that in alternate embodiments one or more of the following dimensions may be greater or lesser, depending upon the particular application: L=29.5 millimeters (mm), H2=15.1 mm and TH2=2 mm.

Referring now to FIG. 13, an alternate embodiment is shown of the frame member 120A″ and of the glazing strip 130A′. The frame member 120A″ is illustratively identical to the frame member 120A illustrated in FIGS. 10A and 12 except that the channel 145 is replaced with an opening 145′ defined between a terminal end 141 of a modified front wall 144″ extending downwardly from one end of the top wall 144 and a junction of the front wall 140 and the side wall 154. The opening 145′ illustratively opens to a pocket 145″ defined between a modified side wall 152′, the top wall 144, the modified front wall 144″ and the side wall 154. One end of the modified side wall 152′ is coupled to a junction of the walls 148, 150 and 154, as with the side wall 152 of the embodiment illustrated in FIG. 10A, although an opposite end of the modified side wall 152′ is coupled to the top wall 144 as depicted by example in FIG. 13.

The body 135 of the glazing strip 130A′ is identical to the body 135 of the glazing strip 130A illustrated in FIGS. 11 and 12. The flange 134′ of the glazing strip 130A′ includes a flange body 133 illustratively extending from a free end 133A to an opposite end coupled to one end of a substantially planar and wall 137 having an opposite end coupled to a corresponding end of the wall 172 of the body 135. The planar wall 137 illustratively forms a plane that is parallel with the plane formed by the planar top surface of the top wall 174. The junction at the coupled ends of the flange 133 and the wall 137 illustratively forms a raised tip or protrusion 139 which, together with the inner surfaces of the walls 137 and 172, forms a pocket 137A sized to receive therein the terminal end 141 of the modified front wall 144′ of the frame member 120A″ as depicted by example in FIG. 13. The flange body 133 illustratively forms an acute angle with respect to the plane formed by the planar outer surface 174A of the top wall 174 as described above with respect to FIGS. 9A-12. The junction defined between the wall 137 and the wall 172 illustratively defines a hinge 184 between the flange 134′ and the body 135 of the glazing strip 130A′ as described above. As the flange body 133 is fully inserted through the opening 145′ and into the pocket 145″, the frame member 120A″ engages the flange 134′, and the combination of the end 144A of the top wall 144 of the frame member 120A″ and the inwardly facing edge of the door skin 105A act against the leg 172 to cause the body 135 of the glazing strip 130A′ to rotate or pivot away from the flange body 133 about the hinge 184 and thereby force the bottom surface 180 of the body 135 into contact with the outer surface of the IG panel 126A to retain the IG unit 124 within the opening 102 defined through the door 102, as described above. In some embodiments, the glazing strip 130A′ may be configured such that rotation or pivoting of the body 135 away from the flange 134′ about the hinge 184 also forces the top surface 174A of the top wall 174 (i.e., either the entire top surface 174A in embodiments in which the top surface 174A is planar, or the top-most peak of the top surface 174A in embodiments in which the top surface 174A is non-planar) to be substantially flush with the planar outer surface of the door skin 105A. In any case, in this position, the terminal end 141 of the modified front wall 144′ is received in the pocket 137A and maintained therein by the combination of the tip or protrusion 139 and the inwardly-facing surface of the wall or leg 172. In some alternate embodiments, the end 144A of the top wall 144 of the frame member 120A may extend beyond the inwardly facing terminal edge of the door skin 105A, and in such embodiments only the end 144A of the top wall 144 of the frame member 120A will act against the leg 172 to force the body 135 of the glazing strip 130A′ to rotate or pivot away from the flange body 133 as just described. In other alternate embodiments, the inwardly-facing terminal edge of the door skin 105A may extend beyond the end 144A of the top wall 144 of the frame member 120A, and in such embodiments only the inwardly-facing terminal edge of the door skin 105A will act against the leg 172 to force the body 135 of the glazing strip 130A′ to rotate or pivot away from the flange body 133 as just described.

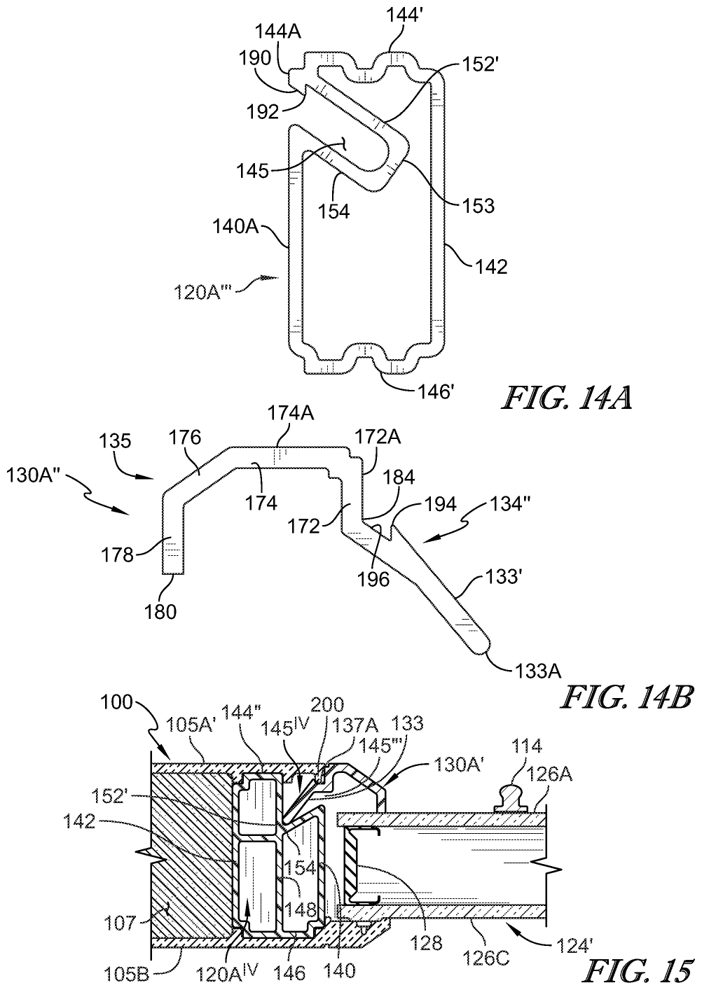

Referring now to FIGS. 14A and 14B, another alternate embodiment is shown of the frame member 120A″ and of the glazing strip 130A″. The frame member 120A′″ is illustratively identical to the frame member 120A illustrated in FIGS. 10A and 12 except that the top and bottom walls 144′, 146′ respectively are configured to each include an additional key pocket configured to engage another key formed in the inwardly-facing surfaces of the respective door skins 105A, 105B (extra key formed in the inwardly-facing surface of the door akin 105A′ illustrated by example in FIG. 15), and except that the side wall 152′ of the channel 145 includes a protrusion 190 extending into the channel 145 adjacent to the opening of the channel 145. Illustratively the end portion of the protrusion 190 opposite the end wall 153 of the channel 145 defines a pointed tooth 192 configured such that the point of the tooth is rearwardly-oriented, i.e., such that the point of the tooth is oriented to face the end wall 153 of the channel 145.

The body 135 of the glazing strip 130A″ may be identical or similar to the body 135 of the glazing strip 130A illustrated in FIGS. 11 and 12. The flange 134″ of the glazing strip 130A″ is illustratively similar to the flange 134′ of the glazing strip 130A′ and includes a flange body 133′ illustratively extending from a free end 133A to an opposite end coupled to one end of the wall 172 of the body 135. The flange body 133′ illustratively defines a raised tip 194 spaced apart from the junction of the coupled ends of the flange 133′ and the wall 172, and a sloped pocket 196 is defined between the raised tip 194 and the junction of the coupled ends of the flange 133′ and the wall 172. The flange body 133′ illustratively forms an acute angle with respect to the plane formed by the planar outer surface 174A of the top wall 174 as described above with respect to FIGS. 9A-12. The junction defined between the flange body 133′ and the wall 172 illustratively defines a hinge 184 between the flange 134″ and the body 135 of the glazing strip 130A″ as also described above. Illustratively, the sloped pocket 196 is configured complementarily to the surface of the protrusion 190 facing the channel 145 of the frame member 120A″, and the raised tip 194 is configured complementarily to the pointed tooth 192 of the frame member 120A′″ such that as the flange body 133′ is fully inserted into the channel 145 of the frame member 120A′″ illustrated in FIG. 14A, the protrusion 190 is received within the pocket 196 and the raised tip 194 engages the tooth 192 so as to retain the flange body 133′ within the channel 145. Also, as the flange body 133′ is fully inserted into the channel 145, the combination of the end 144A of the top wall 144 of the frame member 120A″ and the inwardly facing terminal edge of the door skin 105A act against the leg 172 to cause the body 135 of the glazing strip 130A′ to rotate or pivot away from the flange body 133′ about the hinge 184 and thereby force the bottom surface 180 of the body 135 into contact with the outer surface of the IG panel 126A to retain the IG unit 124 within the opening 102 defined through the door 102, as described above. In some embodiments, the glazing strip 130A may be configured such that rotation or pivoting of the body 135 away from the flange 134″ about the hinge 184 also forces the top surface 174A of the top wall 174 (i.e., either the entire top surface 174A in embodiments in which the top surface 174A is planar, or the top-most peak of the top surface 174A in embodiments in which the top surface 174A is non-planar) to be substantially flush with the planar outer surface of the door skin 105A. In any case, in this position, the flange body 133′ is maintained in the channel 145 by the protrusion 190 received within the pocket 196 and engagement of the raised tip 194 with the pointed tooth 192. In some alternate embodiments, the end 144A of the top wall 144 of the frame member 120A″ may extend beyond the inwardly facing terminal edge of the door skin 105A, and in such embodiments only the end 144A of the top wall 144 of the frame member 120A″ will act against the leg 172 to force the body 135 of the glazing strip 130A″ to rotate or pivot away from the flange body 133′ as just described. In other alternate embodiments, the inwardly-facing terminal edge of the door skin 105A may extend beyond the end 144A of the top wall 144 of the frame member 120A″, and in such embodiments only the inwardly-facing terminal edge of the door skin 105A will act against the leg 172 to force the body 135 of the glazing strip 130A″ to rotate or pivot away from the flange body 133′ as just described.

In some embodiments, the raised tip 194 and/or the pointed tooth 192 may be sufficiently resilient such that the flange body 133′ may be drawn out of the channel 145 so as to remove the glazing strip 130A″ from the frame member 120A′″. In alternate embodiments, the raised tip 194 and the pointed tooth 192 may be sufficiently stiff such that the flange body 133′ may not be removed from the channel 145 without damaging the flange body 133′ and/or the frame member 120A′″.

Referring now to FIG. 15, yet another alternate embodiment is shown of the frame member 120A^{IV} and which may be used the glazing strip 130A′ illustrated in FIG. 13. The frame member 120A^{IV} is illustratively identical to the frame member 120A″ illustrated in FIG. 13 except that the top wall 144″ is truncated so as to terminate at the junction of the top wall 144″ and the side wall 152′. In this embodiment, a protrusion 200 extends from the inner surface of the door skin 105A, at or adjacent to the terminal end of the door skin 105A at the opening 102, toward the inner surface of the opposite door skin 105B, such that the terminal end of the door skin 105A and the junction of the walls 140, 154 of the frame member 120A″ form the opening 145″ to the flange receiving pocket 145″ defined between the walls 152, 154 of the frame member 120A^{IV} and the portion of the door skin 105A′ extending over the wall 154. Illustratively, the protrusion 200 is sized complementarily to the pocket 137A formed in the glazing strip 130A′, such that the protrusion 200 is received within the pocket 137A to perform the function of the terminal end 141 of the modified front wall 144′ of the frame member 120A″ depicted by example in FIG. 13 and described above. Otherwise, insertion and removal of the glazing strip 130A″, and its operation, is as described with respect to FIG. 13 except that, in this embodiment, only the inwardly-facing terminal edge of the door skin 105A acts against the leg 172 to force the body 135 of the glazing strip 130A′ to rotate or pivot away from the flange body 133 as described above.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, although not specifically illustrated in FIGS. 9A-15, the free ends 180 of the bottom wall 178 of the glazing strips 130A, 130A′, 130A″ may illustratively include one or more sealing strips defined on or attached thereto which extend longitudinally along the lengths of the strips 130A, 130A″, 130A′″ to form a seal, e.g. against moisture, air and/or particulates, between the glazing strips 130A, 130A′, 130A″ and the outer surface of a respective panel of the IG unit 124 about its periphery. In some embodiments, the sealing member(s) 42 illustrated by example in FIGS. 5A and 5B may be used, although it will be understood that such sealing members 42 are shown only by way of example and that glazing strips 130A, 130A″, 130A′″ which include sealing strips are not limited to the sealing member(s) 42 shown in FIGS. 5A and 5B.

1.-29. (canceled)

30. In combination:
a door including a first door skin having an outer surface defining one planar surface of the door, a second door skin having an outer surface defining an opposite planar surface of the door, a first opening formed through the door and at least a first glazing strip extending over a periphery of the first opening, the first glazing strip having an inner surface and an outer surface, the outer surface of the first glazing strip flush with the outer surface of the first door skin,
an insulated glass unit (IG), and
a mounting arrangement for flush-mounting the IG in the first opening, the mounting arrangement comprising:
at least one frame member positioned between the first and second door skins along at least one edge of the first opening to form at least one inwardly-facing edge of the first opening,
at least one slot or second opening extending into one of the at least one frame member and the at least one inwardly-facing edge of the first opening between the at least one frame member and the second door skin, and
at least a second glazing strip having body with a top surface and a bottom surface opposite the top surface, and a flange extending away from the body, the at least a second glazing strip configured to be mounted to the door such that, with the IG positioned in the first opening with one outer panel of the IG in contact with the inner surface of the at least a first glazing strip about a periphery of the IG, insertion of the flange into the slot or second opening causes the bottom surface of the body of the at least a second glazing strip to engage an opposite panel of the IG about the periphery of the IG to retain the IG in the first opening with a plane tangent to a peak height of the top surface of the body approximately flush with the second door skin.

31. The combination of claim 30, wherein the top surface of the body of the at least a second glazing strip is planar such that the plane tangent to the peak height of the top surface of the body is a plane defined by the planar top surface of the body.

32. The combination of claim 30, wherein the top surface of the body of the at least a second glazing strip is non-planar.

33. The combination of claim 30, wherein the at least one slot or second opening comprises at least one planar slot extending into the at least one inwardly-facing edge of the first opening between the at least one frame member and the second door skin such that the at least one planar slot is parallel with the opposite planar surface of the door defined by the outer surface of the second door skin,
and wherein the flange is a planar flange extending away from the body of the at least one second glazing strip such that the planar flange is parallel with the bottom surface of the body and with the plane tangent to the peak height of the top surface of the body.

34. The combination of claim 33, wherein the bottom surface of the body of the at least a second glazing strip is a planar bottom surface,
and further comprising at least a first sealing member extending along the planar bottom surface, the at least a first sealing member configured to form a seal between the planar bottom surface and the opposite panel of the IG about the periphery thereof.

35. The combination of claim 34, further comprising at least a second sealing member extending along at least one face of the planar flange, the at least a second sealing member configured to form a friction fit between the flange and the at least one planar slot.

36. The combination of claim 30, wherein the at least one slot or second opening comprises the at least one second opening extending into the at least one frame member,
and wherein the flange forms an acute angle with the plane tangent to the peak height of the top surface of the body,
and wherein insertion of the flange into the second opening engages the at least one frame member with the flange to secure the flange to the at least one frame member.

37. The combination of claim 36, wherein the at least one frame member defines a channel in communication with the opening,
and wherein the channel and the flange are configured to engage one another so as to retain the flange within the channel.

38. The combination of claim 36, wherein one of the flange and the channel defines at least one protrusion extending from a surface thereof, and the other of the flange and the channel defines at least one notch configured to engage the at least one protrusion upon insertion of the flange into the channel.

39. The combination of claim 36, wherein the at least a second glazing strip defines a hinge between the body and the flange,
and wherein, upon insertion of the flange into the opening defined in the at least one frame member, at least one of the at least one frame member and a terminal edge of the second door skin along the at least one edge of the opening of the door act against the body to rotate or pivot the body relative to the flange about the hinge so as to force the bottom surface of the body into contact with opposite outer panel of the IG to retain the IG in the opening.

40. The combination of claim 39, wherein rotating or pivoting of the body relative to the flange about the hinge forces the plane tangent to the peak height of the top surface of the body approximately flush with the outer surface of the second door skin.

41. The combination of claim 36, further comprising a blind adjustment track mounted to an outer surface of the IG adjacent to the second door skin such that the blind adjustment track extends approximately parallel with, and spaced apart by a distance D from, the body of the at least a second glazing strip with the flange inserted into the opening defined in the at least one frame member,
and wherein the acute angle formed by the flange with respect to the plane tangent to the peak height of the top surface of the body is selected, taking into account the distance D, such that the blind adjustment track will not impede the insertion into, or removal of, the flange into or out of the opening defined in the at least one frame member.

42. The combination of claim 36, wherein the opening defined in the at least one frame member defines at least a first retention structure and the flange defines at least a second retention structure,
and wherein the at least a first retention structure and the at least a second retention structure are complementarily configured to engage one another as the flange is inserted into the opening defined in the at least one frame member so as to retain the flange within the at least one frame member.

43. The combination of claim 42, wherein the at least a first retention structure and the at least a second retention structure are both configured to releasably engage one another such that the flange can be withdrawn from the opening defined in the at least one frame member.

44. The combination of claim 42, wherein the at least a first retention structure and the at least a second retention structure are both configured to non-releasably engage one another such that, following engagement of the at least a first retention structure and the at least a second retention structure, the flange cannot thereafter be withdrawn from the opening defined in the at least one frame member without damaging at least one of the flange and the at least one frame member.

45. The combination of claim 36, wherein the top surface of the body of the at least a second glazing strip is one of planar, such that the plane tangent to the peak height of the top surface of the body is a plane defined by the planar top surface of the body, or non-planar.

46. The combination of claim 30, wherein the at least one frame member comprises a plurality of frame members each positioned between the first and second door skins along a different respective edge of the opening of the door such that the plurality of frame members together extend continuously or discontinuously about a periphery of the opening of the door,
and wherein the at least a second glazing strip comprises a plurality of second glazing strips together extending continuously about the periphery of the opening of the door and each configured to engage a different respective one of the plurality of frame members.

47. The combination of claim 30, wherein the at least a first glazing strip is integral with the first door skin such that the first door skin and the at least a first glazing strip are of unitary construction.

48. The combination of claim 30, wherein the at least a first glazing strip is separate from the first door skin and configured to be coupled to the at least one frame member.

49. A mounting arrangement for flush-mounting an insulated glass unit (IG) in a first opening defined through a door including a first door skin having an outer surface defining one planar surface of the door, a second door skin having an outer surface defining an opposite planar surface of the door and at least a first glazing strip extending over a periphery of the first opening and having an outer surface flush with the outer surface of the first door skin, the mounting arrangement comprising:
at least one frame member positioned between the first and second door skins along at least one edge of the first opening to form at least one inwardly-facing edge of the first opening,
at least one slot or second opening extending into one of the at least one frame member and the at least one inwardly-facing edge of the first opening between the at least one frame member and the second door skin, and
at least a second glazing strip having body with a top surface and a bottom surface opposite the top surface, and a flange extending away from the body, the at least a second glazing strip configured to be mounted to the door such that, with the IG positioned in the first opening with one outer panel of the IG in contact with the inner surface of the at least a first glazing strip about a periphery of the IG, insertion of the flange into the slot or second opening causes the bottom surface of the body of the at least a second glazing strip to engage an opposite panel of the IG about the periphery of the IG to retain the IG in the first opening with a plane tangent to a peak height of the top surface of the body approximately flush with the second door skin.
